(19) United States
(12) Patent Application Publication
(10) Pub. No.: US 2007/0163257 A1
(43) Pub. Date: Jul. 19, 2007

(54) Inline turbo blow off valve

(76) Inventor: Leen David Steed, Didsbury (CA)

Correspondence Address: Leen D. Steed, 8751 33 AV NW, CALGARY, AB, T3B 1M2, CA

(21) Appl. No.: 11/334,079

(22) Filed: Jan. 19, 2006

(51) Int. Cl. F02B 33/44; F02D 23/00

(52) U.S. Cl. 60/598; 60/600; 60/605.1

(57) ABSTRACT

This invention provides an improved “blow off valve” for use on turbocharged engines. The valve is of a new style having a main body which is comprised of a tube which can be incorporated into the charge air plumbing of a turbocharged engine. The tube is perforated around its circumference creating ports through which the pressurized air from a turbocharger can escape. The ports are covered during normal running conditions by an annular sleeve which fits over the main tube body. The sleeve is able to slide back and forth along the main body tube and in doing so it can alternately cover or uncover the ports in the main body. The sleeve is constructed in such a way that it acts as a pneumatic piston and is moved back and forth by alternate conditions of vacuum or positive pressure that are applied to it. To ensure the valve is closed on starting the engine the sleeve is also assisted in closing by several springs which hold the valve closed until a vacuum from the intake manifold can pull the sleeve back and uncover the ports in the main body. Because this valve can be installed as an integral part of the charge air piping it will make installation much easier than the currently available products which have to be attached to the side of the existing charge pipes using welded flanges and pipes.

### BACKGROUND

One of the problems encountered with turbo charged engines is that, when a driver lifts their foot off the throttle, they effectively close off the charge air pipes used to deliver pressurized air to the engine. When the throttle closes the engine slows down and is not adversely affected by the change. Unfortunately the same can not be said for the turbocharger which will still be spinning from its inertia at around 100,000 rpms and is still trying to force pressurized air into the engine. With the throttle closed the pressurized air will hit a dead end and will be forced back as a high pressure wave into the turbocharger. When the pressure wave hits the turbo it will instantly slow the rotating element of the turbo to a fraction of its operating speed, otherwise known as “turbo lag”. This severe deceleration can cause damage to the turbo and also will reduce the power of the engine when the driver reopens the throttle as there will be a delay in power production while the turbocharger takes time to spin back up to its operating speed. To counter this detrimental effect, a valve is commonly used to vent pressurized air to the atmosphere when the throttle is closed. Under normal running conditions these valves are held closed by springs and also by the boost pressure taken from the intake manifold and applied to an actuating piston. When the throttle is closed it creates a powerful vacuum inside the intake manifold and this vacuum is used to pull open the “blow off valve” so that air from the turbo can be vented to the atmosphere rather than hammering back into the turbo. Thus the turbo is able to keep spinning without obstruction and will be able to quickly deliver pressurized air to the engine when the throttle is opened again. All of the currently available valves are attached to charge air pipes using mounting flanges. which must be welded to the charge pipes by professional installers resulting in higher costs and added complications for the consumer. Those skilled in the art will recognize that an easily installed blow off valve would have many applications for turbo charged engines.

### SUMMARY OF THE INVENTION

It is therefore the object of this invention to provide a new style of Blow off valve which is more easily installed than those currently available on the market. It achieves its objective through a design which enables the valve to become an integral part of the charge air piping which is easily installed by simply using silicone rubber couplings to join each end to the charge air pipes.

### DESCRIPTION OF DRAWINGS

The following detailed description may be best understood in conjunction with the accompanying diagrams where parts are labeled with numbers and letters for ease of reference.

FIG. 1. Shows a cross sectional view of the valve. The main body “A” is comprised of a tube having an annular projection “C” which, when assembled with moving sleeve B creates a closed chamber “I”. O rings are used at two locations “D” to seal the chamber between Main body “A” and moving sleeve “B”. The closed chamber can be pressurized through port “G” to push moving ring “B” into O ring “H” and in doing so will cover and seal off the ports “F” which are cut through main body “A”. The valve is also held closed by springs at “E”.

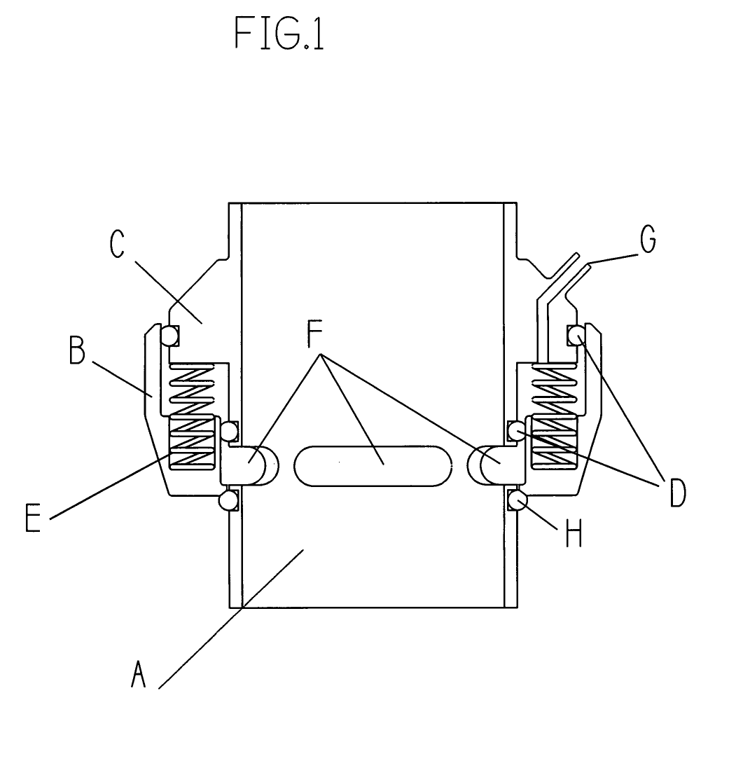

FIG. 2. This cross section shows the valve as it would be when a vacuum is applied to the chamber created between parts “A” and “B”. The vacuum has pulled moving ring “B” back towards the annular projection “C” on main body “A” and in so doing has uncovered the ports “F” in the main body “A”. The springs “E” are compressed in this drawing

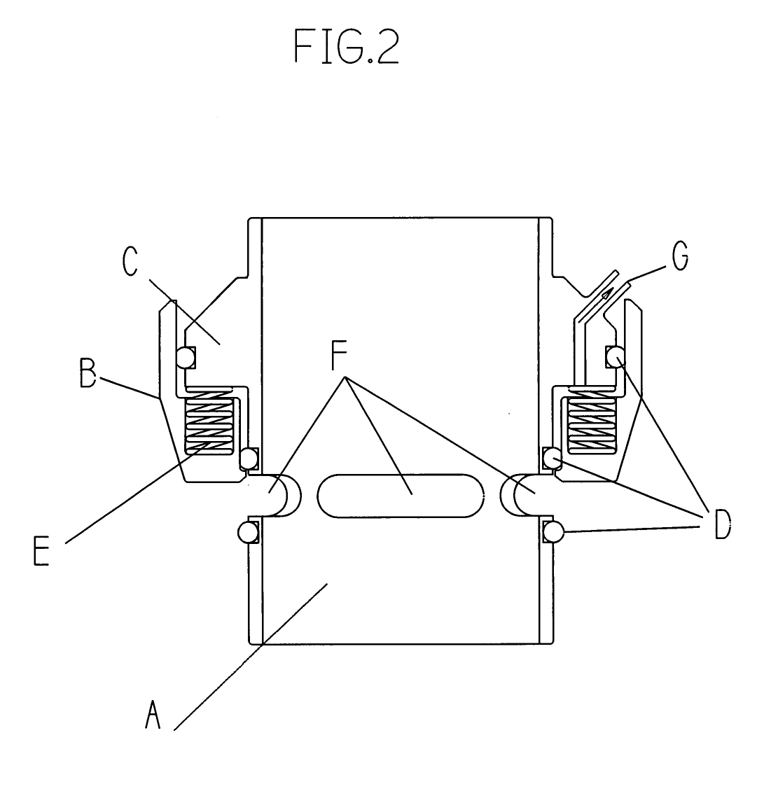

FIG. 3. shows a cross section of the valve as installed in line with the pipes of a turbo system. Pipe “X” is coming from a turbo charger and pipe “Y” is going to the engine. The valve is therefore a part of the plumbing and is itself a short section of the pipe work. The valve is secured to the incoming and out going pipes using soft rubber sleeves “Z” which can be held tight to the pipes and the valve using standard hose clamps.

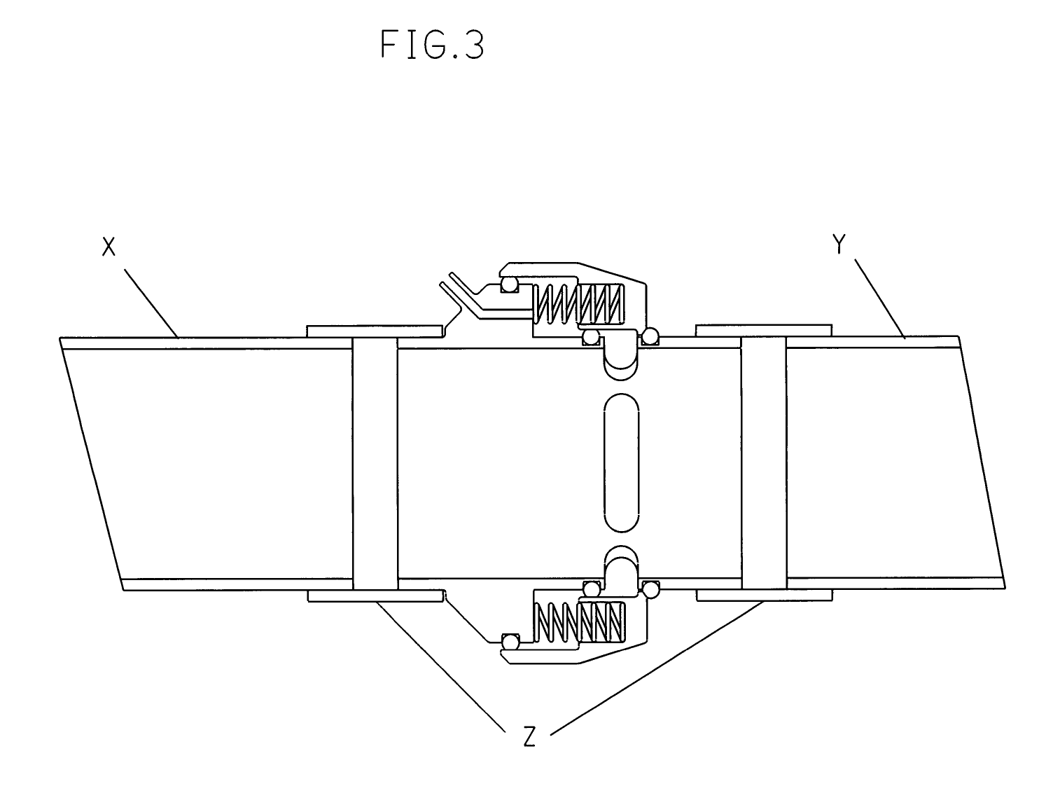

FIG. 4. Shows an isometric view of the valve sectioned to show the main body “A”. Moving ring “B”. Exhaust ports “F”, O ring seals at “D” and the main valve seal at “H”.

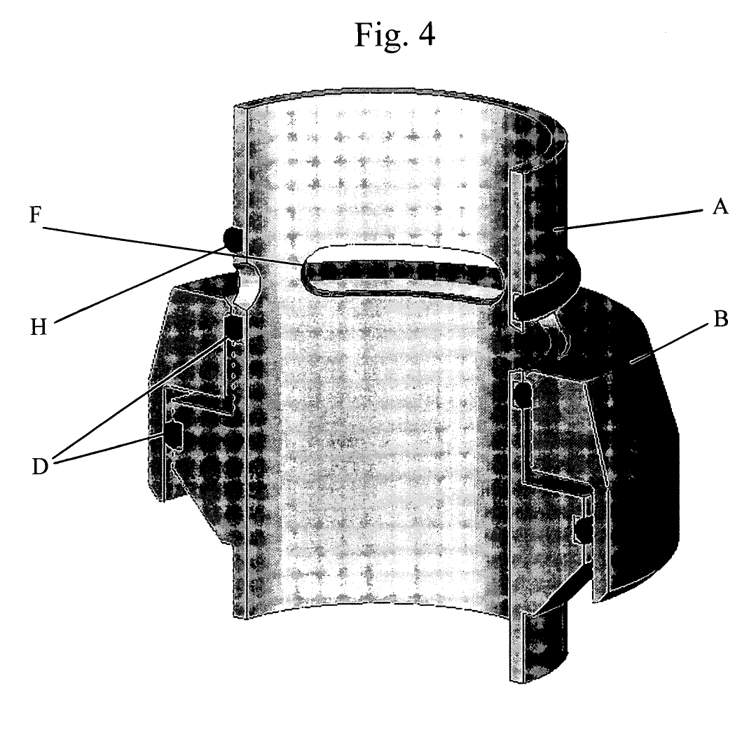

### DETAILED DESCRIPTION OF THE EMBODIMENT

The invention is an improved version of an existing product used on turbo charged engines. The invention is an improved design for turbo blow off valves which is more easily installed on the customers vehicle than current designs. It comprises a main body which doubles as part of the valve and also becomes an integral piece of the plumbing to deliver pressurized air to the engine. This main body has ports cut into it to allow pressurised air to escape when the engines throttle is closed. When the throttle is open, a sleeve which fits around the outside of the main body covers the ports in the main body preventing compressed air from escaping through the ports in the valve. When the throttle is closed the moving sleeve will be pulled away from the ports in the main body allowing air to escape from the pressurized section of the turbo pipes.

It can be seen that the invention accomplishes all of it's stated objectives. The foregoing is considered as illustrative only of the principles of the invention. further, since numerous changes, modifications and applications will readily occur to those skilled in the art, it is not desired to limit the invention to the exact construction, application and operation shown and described, and accordingly, all such suitable changes or modifications in structure, operation or application which may be resorted to are intended to fall within the scope of the described invention.

I claim:

1: An improved turbo blow off valve having a main tubular body which is installed as an integral part of the charge air plumbing on a turbo charged engine; this main body having ports in its circumference which are alternately covered and uncovered by a sleeve which fits over the main body; this sleeve slides back and forth along the main body being as it is a ring shaped piston which is actuated using either vacuum or air pressure to open and close the ports in the main body at the correct moment to relieve air pressure in the charge air pipes allowing more efficient operation of the turbocharger.

2: A turbo blow off valve which, due to its tubular shape, is able to become an integral part of a turbocharged engines plumbing pipework and is thus much easier to install than currently available designs.

3: An improved turbo blow off valve having greater air flow capability than currently available products due to the valve having exhaust ports around its entire circumference.
